(19) United States
(12) Patent Application Publication
(10) Pub. No.: US 2005/0072638 A1
(43) Pub. Date: Apr. 7, 2005

(54) Shock absorber for vehicle suspension

(76) Inventor: Ju Ho Kim, Hwaseong-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/750,687

(22) Filed: Dec. 31, 2003

(30) Foreign Application Priority Data
Oct. 1, 2003 (KR) 10-2003-0068373

(51) Int. Cl. F16F 9/53

(52) U.S. Cl. 188/267.2

(57) ABSTRACT

Durability and noise/vibration characteristics of a shock absorber for a vehicle are enhanced when the shock absorber includes a cylinder, a piston reciprocally disposed in the cylinder, and a magnetic field generating unit for generating a magnetic field in a radial direction of the piston, wherein the magnetic field generating unit is mounted at one side of an interior side of the cylinder and an exterior side of the piston, and another side of the interior side of the cylinder and the exterior side of the piston at which the magnetic field generating unit is not mounted is formed of a metallic material.

### CROSS-REFERENCE TO RELATED APPLICATIONS

This application claims priority of Korean Application No. 10-2003-0068373, filed on Oct. 1, 2003, the disclosure of which is incorporated fully herein by reference.

### FIELD OF THE INVENTION

Generally, the present invention relates to a shock absorber for a vehicle suspension. More particularly, the present invention relates to a shock absorber for a vehicle suspension that utilizes an electromagnetic force for absorbing a shock.

### BACKGROUND OF THE INVENTION

When a vehicle is running, a suspension controls the vehicle behavior under circumstances such as braking, deceleration, and turning, and also controls wheel motion reactive to a road. Such a suspension includes a shock absorber (also called a damper) to reduce reciprocal wheel motion.

A conventional shock absorber usually operates hydraulically or pneumatically. Therefore, sealing of a fluid or a gas (or air) used in such a conventional shock absorber is an important factor to ensure proper operation thereof. When a shock absorber ages, such sealing may fail and its function of reducing shock becomes weaker.

In addition, such a conventional shock absorber is mechanically driven and thereby noise and vibration can be generated.

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

Embodiments of the present invention provide a shock absorber for a vehicle having non-limiting advantages of enhanced durability and reduced noise/vibration.

An exemplary shock absorber for a vehicle according to an embodiment of the present invention includes a cylinder, a piston reciprocally disposed in the cylinder, and a magnetic field generating unit for generating a magnetic field in a radial direction of the piston. The magnetic field generating unit is mounted at one side of an interior side of the cylinder and an exterior side of the piston. Another side of the interior side of the cylinder and the exterior side of the piston, at which the magnetic field generating unit is not mounted, is formed of a metallic material.

In a further embodiment, an exemplary shock absorber further includes first and second permanent magnets respectively mounted at an uppermost side of the piston and an uppermost interior side of the cylinder. The first and second permanent magnets have opposing polarities.

In another embodiment, the magnetic field generating unit comprises a plurality of unit magnets, and each of the unit magnets is ring-shaped and generates a magnetic field in the radial direction of the piston.

In a yet another embodiment, a predetermined thickness of the exterior side of the piston is made of copper material.

In a yet another embodiment, an exemplary shock absorber further includes a first spring for applying an elastic force to the piston in the direction of motion of the piston. It is preferable that the first spring is disposed above the uppermost side of the piston.

It is further preferable that an exemplary shock absorber further includes a second spring disposed at an end of the first spring distal to the piston, and a rubber member disposed between the first and second springs.

It is preferable that spring supporters are disposed at a lower portion of the piston and an upper portion of the cylinder, and the first spring is abutted between the spring supporters.

In a yet another embodiment, an exemplary shock absorber further includes a rotation restricting unit for restricting rotation of the piston when the piston reciprocates. It is preferable that the rotation restricting unit includes a guide groove longitudinally formed at the piston, and a guide member mounted on an interior wall of the cylinder, the guide member having a projection at a position corresponding to the guide groove. It is also preferable that the rotation restricting unit includes a guide projection longitudinally formed at the piston, and a guide member mounted on an interior wall of the cylinder, the guide member having a groove at a position corresponding to the guide projection.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is sectional view of a shock absorber for a vehicle according to a first embodiment of the present invention;

FIG. 2 shows an exemplary unit magnet used in a shock absorber for a vehicle according to an embodiment of the present invention;

FIG. 3 is a sectional view of FIG. 1 along a line III-III according to an embodiment of the present invention;

FIG. 4 is a sectional view of FIG. 1 along a line III-III according to a variation of an embodiment of the present invention; and

FIG. 5 is a sectional view of a shock absorber for a vehicle according to a second embodiment of the present invention.

### DETAILED DESCRIPTION OF THE PREFERRED EMBODIMENTS

An embodiment of the present invention will hereinafter be described in detail with reference to the accompanying drawings.

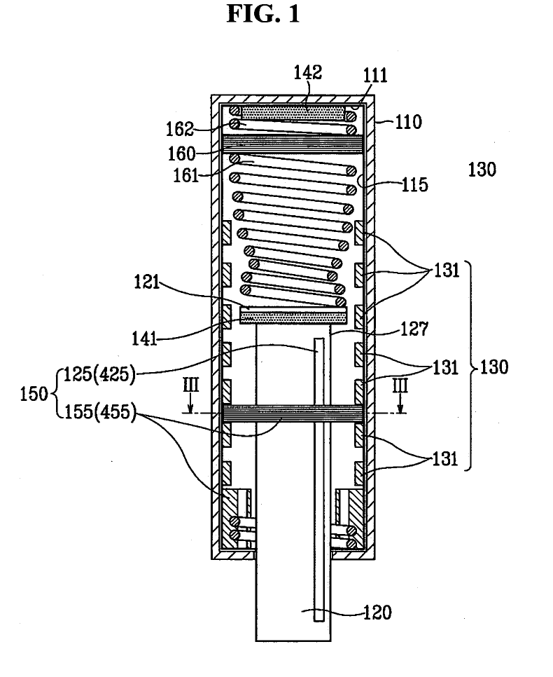

As shown in FIG. 1, a shock absorber for a vehicle according to an embodiment of the present invention includes a cylinder 110, a piston 120 reciprocally disposed in the cylinder 110, and a magnetic field generating unit 130 mounted at an interior side 115 of the cylinder 110. The magnetic field generating unit 130 generates a magnetic field toward the piston 120.

First and second permanent magnets 141 and 142 are respectively mounted at an uppermost side 121 of the piston 120 and an uppermost interior side 111 of the cylinder 110 such that polarities of the first and second permanent magnets 141 and 142 are opposed to each other.

As an example, according to an embodiment of the present invention, as shown in FIG. 1, the first permanent magnet 141 mounted at the uppermost side 121 of the piston 120 has its N-pole upward, and the second permanent magnets 142 mounted at the uppermost interior side 111 of the cylinder 110 has its N-pole downward.

Therefore, such first and second permanent magnets 141 and 142 form a repelling force against each other, and thereby form a force to obstruct upward motion of the piston 120. In addition, the first and second permanent magnets 141 and 142 may prevent collision of the cylinder 110 and the piston 120 when the piston 120 moves in its full stroke.

The magnetic field generating unit 130 includes a plurality of unit magnets 131. Each of the unit magnets 131 is ring-shaped and generates a magnetic field in the radial direction of the piston 120. The unit magnets 131 are preferably permanent magnets.

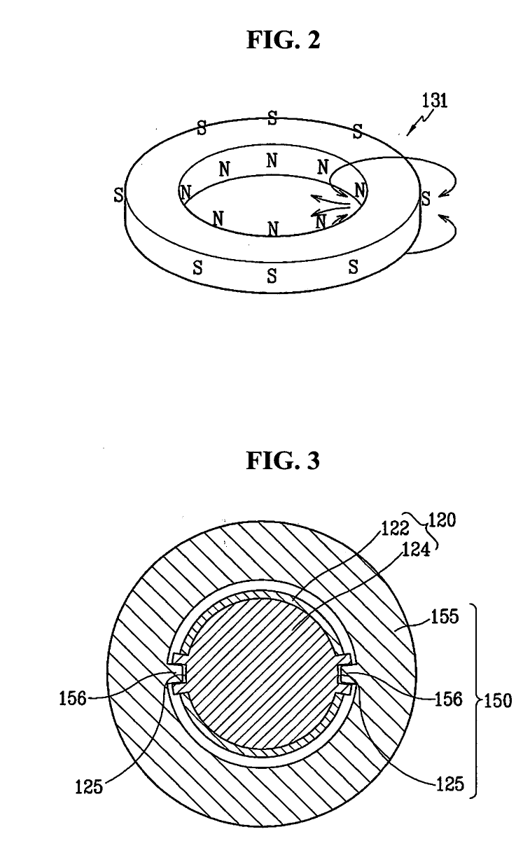

An exemplary unit magnet 131 is shown in FIG. 2. As shown in FIG. 2, according to a first embodiment of the present invention, N- and S-poles of the unit magnet 131 are aligned in a radial direction of the piston 120, wherein the N-pole is facing a center of the piston and the S-pole is facing an exterior circumference of the unit magnet 131. According to such an alignment of polarities, most magnetic fields from the unit magnet 131 become incident to a surface of an exterior side 127 of the piston 120.

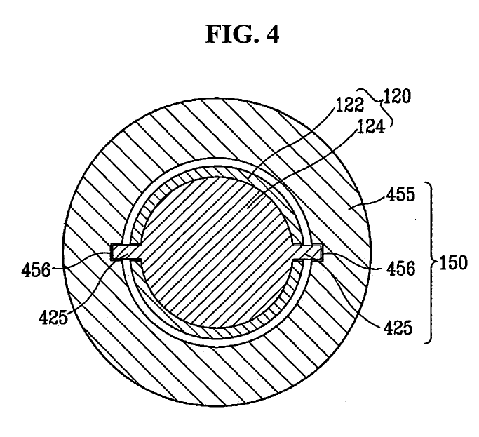

A predetermined thickness of the exterior side 127 of the piston 120 is preferably made of a highly conductive metallic material, such as copper. That is, the surface on which the magnetic field from the unit magnet 131 is incident is made of a copper material. As shown in FIG. 3, a copper plate 122 of a predetermined thickness d (e.g., d=5 mm) is formed at the exterior side 127 of the piston 120. An interior core 124 of the piston 120 is formed of a higher strength material, such as steel. Copper is just one material from which plate 122 may be made. Any metallic material with relatively high electrical conductivity may be used, so long as the other material properties are suitable for the application. Persons of ordinary skill in the art may select other suitable materials based on the teachings contained herein.

A shock absorber according to an embodiment of the present invention further includes a rotation restricting unit 150 for restricting rotation of the piston 120 when the piston 120 reciprocates. As shown in FIG. 3, the rotation restricting unit 150 includes a guide groove 125 longitudinally formed in the piston 120, and a guide member 155 mounted on an interior wall 115 of the cylinder 110. The guide member 155 has a projection portion 156 at a position corresponding to the guide groove 125. Therefore, the projection portion 156 of the guide member 155, by remaining inserted in the guide groove 125 of the piston 120, prevents the piston 120 from rotating when the piston reciprocates.

According to a variation of the first embodiment of the present invention, as shown in FIG. 4, the rotation restricting unit 150 includes a guide projection 425 longitudinally formed at the piston 120, and a guide member 455 mounted on an interior wall 115 of the cylinder 110. The guide member 455 has a groove 456 at a position corresponding to the guide projection 425.

That is, the rotation restricting unit 150 according to such a variation of the first embodiment has locations of its groove and projection interchanged, when compared to the rotation restriction unit 150 according to the first embodiment.

Referring back to FIG. 1, a shock absorber according to an embodiment of the present invention further includes a first spring 161 for applying an elastic force to the piston 120 in a moving direction of the piston 120.

The first spring 161 is disposed above the uppermost side of the piston 120 in the cylinder 110. A second spring 162 is disposed at an end of the first spring 161 distal to the piston 120, and a rubber member 160 is disposed between the first and second springs 161 and 162.

A spring constant of the second spring 162 is smaller that that of the first spring 161. When the piston 120 moves upward, its stroke is absorbed primarily by the second spring 162. When the piston 120 moves upward almost to its maximum stroke, such a marginal stroke is absorbed by the first spring 161.

Based on the rubber member 160 and the first and second springs 161 and 162, a restoring force acts on the piston 120 when the piston moves, and an impact force between the cylinder 110 and the piston 120 may be alleviated when the piston 120 moves upward at its full stroke.

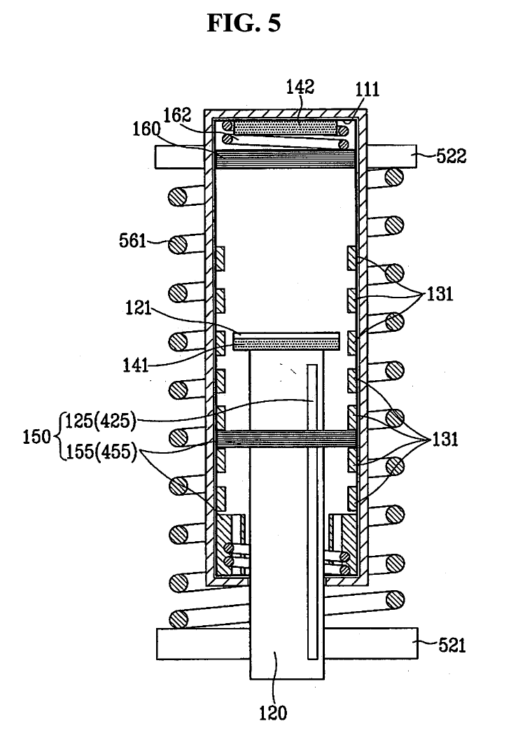

A shock absorber for a vehicle according to a second embodiment of the present invention is hereinafter described in detail with reference to FIG. 5.

According to a shock absorber for a vehicle of the first embodiment, described above with reference with FIG. 1, first and second springs 161 and 162 are disposed inside the cylinder 110 interposing the rubber member 160. However, according to a shock absorber for a vehicle of a second embodiment, a first spring 561 is disposed at an exterior of the cylinder 110. That is, spring supporters 521 and 522 are disposed at a lower portion of the piston 120 and an upper portion of the cylinder 110, and the first spring 561 is abutted between the spring supporters 521 and 522.

Features of the first embodiment that are not contradictory to the first spring 561 may be applied to a shock absorber of this second embodiment. For example, features that are not related to mounting position of the first spring 161, such as the second spring 162, the rubber member 160, and the unit magnet 131, may be applied to a shock absorber according of this second embodiment.

According to a second embodiment of the present invention, the first and second springs 561 and 162 are mounted at separate position, and thereby the elastic effect of the first and second springs 561 and 162 are also separated. Therefore, the first and second springs 561 and 162 may be independently tuned in the process of designing a suspension.

In the above description of an embodiment of the present invention, the unit magnet 131 is described as mounted to the cylinder 110 and the piston 120 is described to be made of a metallic material (i.e., copper) at its exterior side 127. However, the scope of the present invention should not be understood as being limited thereto. Unit magnets may be mounted at the exterior side 127 of the piston 120, and in this case the cylinder may comprise a metallic material (e.g. copper) at its interior side 115.

Operation of a shock absorber for a vehicle according to an embodiment of the present invention is hereinafter described in detail.

Referring back to FIG. 1, the unit magnets 131 form a magnetic field toward the piston 120. Therefore, the magnetic field is incident to the copper plate 122 at an exterior side 127 of the piston 120. In this case, when the piston 120 moves upward or downward, the magnetic field incident to the copper plate 122 changes, and an eddy current is formed at the copper plate 122 such that the change of magnetic field is suppressed. Such an eddy current produces heat in the copper. Since the heat is converted from kinetic energy of the piston 120, the production of such heat causes reduction of the kinetic energy of the piston 120. Therefore, a vertical speed of the piston 120 is reduced by an interaction between the copper plate 122 fixed to the piston 120 and the magnets 131 fixed to the cylinder 110.

The heat from the eddy current produced by a change of the magnetic field incident on a conductor becomes greater as an incident area receiving the magnetic field becomes greater, and as conductivity of the conductor becomes greater. Therefore, considering this factor, the metallic material of the exterior side 127 of the piston 120 is chosen as copper.

In addition, considering that the wider the copper plate 122, the bigger the damping effect, it is preferable that the copper plate 122 is formed entirely around core 124 except at the guide groove 125.

The strength of the eddy current produced by changes of the magnetic field incident to a conductor depends on a depth from a surface of the conductor. That is, as a position becomes deeper from a surface of the conductor, the eddy current at the position becomes weaker. A skin depth is defined as a depth of a position where the eddy current becomes 1/e of the eddy current at the surface of the conductor, and the skin depth has a value of

$$d = \sqrt{\frac{2}{{ωμ}_{0} σ}} .$$

Here, ω denotes an angular velocity of a changing magnetic field, μ₀ denotes a magnetic permeability of vacuum, and σ denotes conductivity of a conductor.

A skin depth of copper is sufficiently small under normal operating conditions of a vehicle suspension, and therefore a plate-shaped copper member may produce sufficiently large eddy currents. Therefore, the copper plate having its thickness of approximately 5 mm as described above may sufficiently reduce motion of the piston.

According to an embodiment of the present invention, friction is minimized during an operation of a shock absorber since decay of motion of a piston is realized by an electromagnetic effect. Therefore, vibration and/or noise that may be produced during an operation of a shock absorber are also minimized.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A shock absorber for a vehicle comprising:
a cylinder;
a piston reciprocally disposed in the cylinder; and
magnetic field generating unit for generating a magnetic field in a radial direction of the piston, the magnetic field generating unit includes a plurality of unit magnets wherein each of the unit magnets is substantially ring-shaped and configured such that an imaginary line connecting a north pole to a south pole is arranged substantially perpendicular to a direction of motion of the piston;
wherein the magnetic field generating unit is mounted at one of an interior side of the cylinder or an exterior side of the piston; and
an interior side of the cylinder or an exterior side of the piston opposite the magnetic field generating unit is formed of a metallic material with relatively high electrical conductivity.

2. The shock absorber of claim 1, further comprising first and second permanent magnets respectively mounted at an uppermost side of the piston and an uppermost interior side of the cylinder, the first and second permanent magnets having opposing polarities.

3. Previously Canceled

4. The shock absorber of claim 1, wherein the magnetic field generating unit is mounted at the interior side of the cylinder and a predetermined thickness of the exterior side of the piston is made of a copper material.

5. The shock absorber of claim 1, wherein the magnetic field generating unit is mounted at the exterior side of the piston and a predetermined thickness of the interior side of the cylinder is made of a copper material.

6. The shock absorber of claim 1, further comprising a first spring applying an elastic force to the piston in a moving direction of the piston.

7. The shock absorber of claim 6, wherein the first spring is disposed above the uppermost side of the piston.

8. A shock absorber for a vehicle comprising:
a cylinder;
a piston reciprocally disposed in the cylinder;
magnetic field generating unit for generating a magnetic field in a radial direction of the piston, wherein the magnetic field generating unit is mounted at one of an interior side of the cylinder or an exterior side of the piston and an interior side of the cylinder or an exterior side of the piston opposite the magnetic field generating unit is formed of a metallic material with relatively high electrical conductivity;
a first spring applying an elastic force to the piston in a moving direction of the piston, wherein the first spring is disposed above the uppermost side of the piston;
a second spring disposed at an end of the first spring distal to the piston; and
a rubber member disposed between the first and second springs.

9. The shock absorber of claim 6, wherein spring supporters are disposed at a lower portion of the piston and an upper portion of the cylinder, and the first spring is abutted between the spring supporters.

10. The shock absorber of claim 1, further comprising a rotation restricting unit for restricting rotation of the piston when the piston reciprocates.

11. The shock absorber of claim 10, wherein the rotation restricting unit comprises:
a guide groove longitudinally formed at the piston; and
a guide member mounted on an interior wall of the cylinder, the guide member having a projection at a position corresponding to the guide groove.

12. The shock absorber of claim 10, wherein the rotation restricting unit comprises:
a guide projection longitudinally formed at the piston; and
a guide member mounted on an interior wall of the cylinder, the guide member having a groove at a position corresponding to the guide projection.

13. A shock absorber, comprising:
a longitudinally extending cylinder;
a piston reciprocally disposed within said cylinder; and
at least one magnetic field generating unit for generating a magnetic field in a radial direction substantially perpendicular to a longitudinal axis of said cylinder, where the magnetic field generating unit is configured such that an imaginary line connecting a north pole to a south pole of the magnetic field generating unit is arranged substantially perpendicular to a direction of motion of the piston;
wherein the magnetic field generating unit is coupled at either an interior surface of the cylinder or an exterior surface of the piston and an interior surface of the cylinder or an exterior surface of the piston, opposite the magnetic field generating unit, is formed of a metallic material with relatively high electrical conductivity.
